(19) United States
(12) Patent Application Publication
(10) Pub. No.: US 2012/0006146 A1
(43) Pub. Date: Jan. 12, 2012

(54) COLLAPSIBLE CONTROL LEVER

(76) Inventors: Vincent M. Warren, Sweet Home, OR (US); Loretta E. Warren, Sweet Home, OR (US)

(21) Appl. No.: 13/240,414

(22) Filed: Sep. 22, 2011

Related U.S. Application Data
(63) Continuation-in-part of application No. 10/121,136, filed on Apr. 10, 2002.
Application No. 10/121,136 is a continuation-in-part of application No. 08/982,130, filed on Dec. 1, 1997, now Pat. No. 6,047,611.
(60) Provisional application No. 61/473,029, filed on Apr. 7, 2011.

(51) Int. Cl. G05G 1/04

(52) U.S. Cl. 74/524

(57) ABSTRACT

A collapsible lever assembly for controlling a system is pivotable between a neutral position and an actuated position relative to a pivot base to control the system. The lever assembly is also moveable between the neutral position and a collapsed position.

### CROSS-REFERENCE TO RELATED APPLICATIONS

This application is a continuation-in-part of U.S. patent application Ser. No. 10/121,136, filed Apr. 10, 2002, which is a Reissue of U.S. patent application Ser. No. 08/982,130, filed on Dec. 1, 1997, which issued as U.S. Pat. No. 6,047,611.

This application also claims the benefit of U.S. Provisional Application No. 61/473,029, filed on Apr. 7, 2011.

The entire disclosures of each of the above applications are incorporated herein by reference.

### FIELD

The present disclosure relates to a control lever and, more particularly, to a collapsible control lever.

### BACKGROUND

This section provides background information related to the present disclosure which is not necessarily prior art.

Elongate levers can be used to control various systems. For instance, motorcycles, bicycles, and other vehicles can include hand-actuated levers adjacent to handlebars used to control a clutch of a transmission system, or a braking system. Other levers on other devices can be used to control other systems as well.

Oftentimes, these control levers are moveably attached to a base, such as a handlebar on a motorcycle or bicycle, or a base of another vehicle, or a base of another type of device. Also, the lever can have a neutral position and an actuated position. For instance, on a motorcycle where the lever controls a braking system, the lever can be angled away from the handlebar in a neutral position during normal riding such that the braking system is not activated. Then, when the rider wants to decelerate, the rider can squeeze, rotate, or pull the lever toward the handlebar to thereby activate the braking system.

Typically, the control lever is positionable only in these two positions (neutral position and actuated position). This can limit the usefulness of the control lever.

### SUMMARY

This section provides a general summary of the disclosure, and is not a comprehensive disclosure of its full scope or all of its features.

A collapsible lever assembly for controlling a system is disclosed. The lever assembly is pivotable between a neutral position and an actuated position relative to a pivot base to control the system. The lever assembly is also moveable between the neutral position and a collapsed position. The lever assembly includes a first section that is pivotally attached to the pivot base to pivot about a first axis of rotation relative to the pivot base to move the lever assembly between the neutral position and the actuated position. The lever assembly also includes a second section that is pivotally attached to the first section to pivot about a second axis of rotation relative to the first section to move the lever assembly between the neutral position and the collapsed position. Moreover, the lever assembly includes an adjustment member that selectively adjusts the neutral position of the lever assembly relative to the pivot base.

Moreover, a collapsible lever assembly for controlling a system is disclosed. The lever assembly is pivotable between a neutral position and an actuated position relative to a pivot base to control the system. The lever assembly is also moveable between the neutral position and a collapsed position. The lever assembly includes a first section that is pivotally attached to the pivot base to pivot about a first axis of rotation relative to the pivot base to move the lever assembly between the neutral and actuated positions. The lever assembly also includes a second section that is attached to the first section and a third section that includes a first portion of an elongate handle and a second portion of the elongate handle. The first portion of the elongate handle is pivotally attached to the second section to pivot about a third axis of rotation relative to the second section to move the lever between the neutral position and the collapsed position. The second portion of the elongate handle is moveably attached to the first portion of the elongate handle to thereby vary a dimension of the elongate handle.

Still further, a collapsible lever assembly for controlling a system is disclosed. The lever assembly is pivotable between a neutral position and an actuated position relative to a pivot base to control the system. The lever assembly is also moveable between a neutral position and a collapsed position. The lever assembly includes a first section that is pivotally attached to the pivot base to pivot about a first axis of rotation relative to the pivot base to move the lever assembly between the neutral position and the actuated position. The lever assembly also includes a second section that is pivotally attached to the first section to pivot about a second axis of rotation relative to the first section to move the lever assembly between the neutral position and the collapsed position. The lever assembly further includes a linkage with an end that is moveably coupled to the first section. The end moves in concert with the first section when the first section pivots about the first axis of rotation to thereby control the system.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a bottom view of a control lever assembly according to teachings of the present disclosure;

FIG. 2A is a top view of the lever assembly of FIG. 1;

FIG. 2B is a front view of the lever assembly of FIG. 1;

FIG. 3A is a bottom view of a control lever assembly according to additional teachings of the present disclosure;

FIG. 3B is a front view of the lever assembly of FIG. 3A;

FIGS. 4A and 4B are top views of an adjustment member of the lever assembly of FIGS. 3A and 3B;

FIG. 5A is a bottom view of a lever assembly according to additional teachings of the present disclosure;

FIG. 5B is a detail view of a biasing member of the lever assembly of FIG. 5A;

FIG. 6A is a bottom view of a lever assembly according to additional teachings of the present disclosure;

FIG. 6B is a front view of the lever assembly of FIG. 6A;

FIG. 7 is a bottom view of a lever assembly according to additional teachings of the present disclosure;

FIG. 8 is a bottom view of a lever assembly according to additional teachings of the present disclosure;

FIG. 9A is a top, partially sectional view of a lever assembly according to additional teachings of the present disclosure; and

FIG. 9B is an exploded isometric view of the lever assembly of FIG. 9A.

Corresponding reference numerals indicate corresponding parts throughout the several views of the drawings.

### DETAILED DESCRIPTION

Example embodiments will now be described more fully with reference to the accompanying drawings.

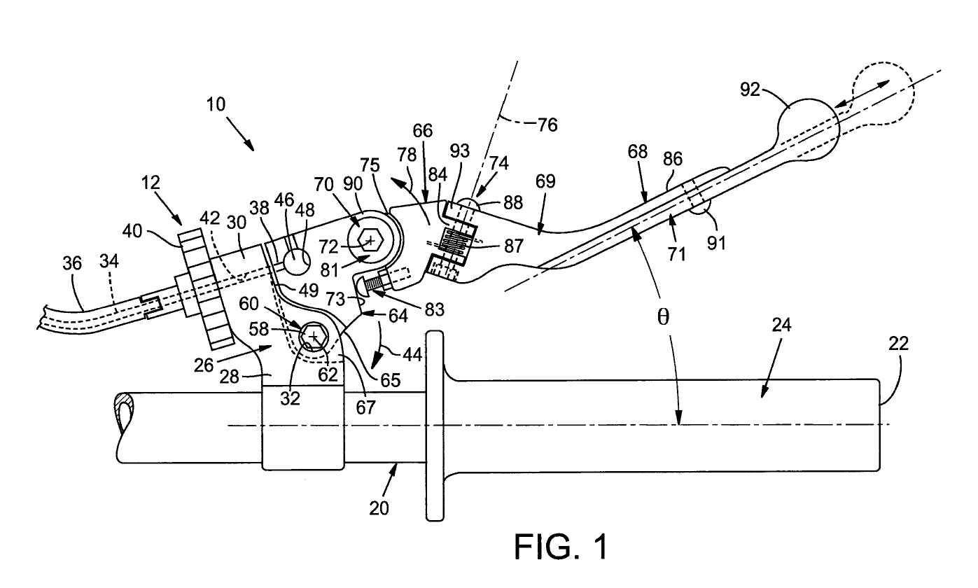

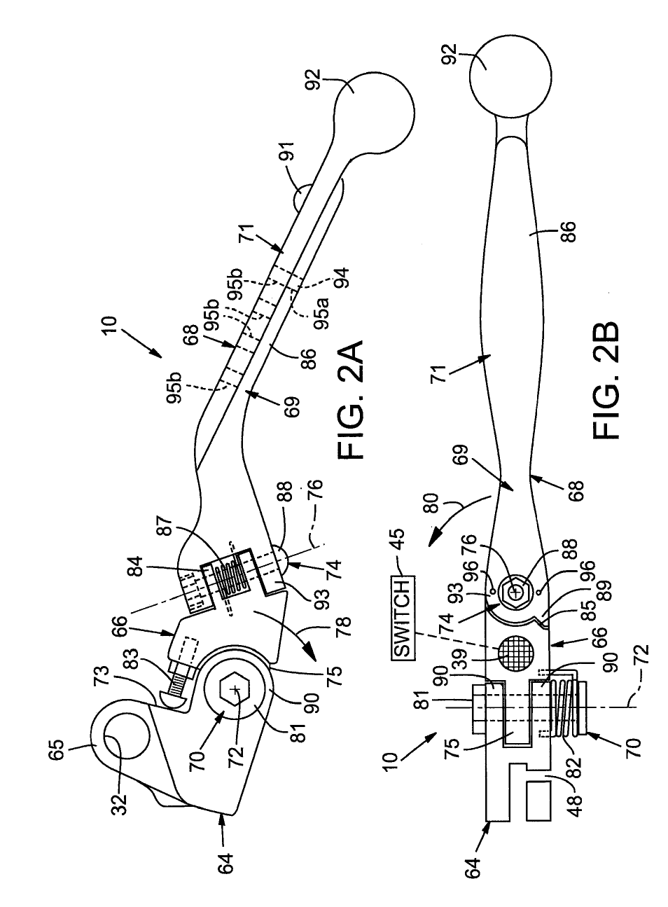

A collapsible lever assembly 10 according to various exemplary embodiments of the present disclosure is illustrated in FIGS. 1, 2A, and 2B. As shown in FIG. 1, the lever assembly 10 can be included on a vehicle, such as a bicycle, a motorcycle (e.g., a dirt bike or a street bike), or any other suitable vehicle, and the lever assembly 10 can be operably coupled to a system, such as a vehicle braking system that controls vehicle deceleration, a vehicle clutch system that controls a vehicle transmission, etc. Thus, as will be discussed in greater detail below, the lever assembly 10 can be hand (or foot) actuated by the user between a neutral position and an actuated position to control the braking system (i.e., to apply the brakes to decelerate the vehicle), to control the clutch (i.e., to pop the clutch for shifting gears), etc. It will be appreciated, however, that the lever assembly 10 can be included on any object other than a vehicle, and the lever assembly 10 can control any system other than a vehicle braking system or a vehicle clutch system without departing from the scope of the present disclosure.

Moreover, as will be discussed in greater detail below, the lever assembly 10 can be collapsible (i.e., the lever assembly 10 can be movable between the neutral position and one or more collapsed positions). In some embodiments, the lever assembly 10 remains in the neutral position for normal driving/riding of the vehicle. However, if the vehicle is involved in an accident or other event, the rider might impact the lever assembly 10, causing the lever assembly 10 to move to its collapsed position. As such, the lever assembly 10 is less likely to do damage or to injure the rider. However, it will be appreciated that the lever assembly 10 could collapse due to other circumstances as well without departing from the scope of the present disclosure.

As shown in FIG. 1, the lever assembly 10 can be operably coupled to a control system 12. Various aspects of the construction and use of the control system 12 may be of a known type, such as those types disclosed in U.S. Pat. No. 4,088,040 to Ross-Myring, U.S. Pat. No. 4,726,252 to Dawson, U.S. Pat. No. 4,730,509 to Homady, and U.S. Pat. No. 6,047,611 to Warren et al., which are each incorporated by reference in its entirety.

As shown in FIG. 1, the control system 12 can include a handlebar 20 having an end 22. A handle grip 24, usually constructed of a resilient material, can be secured to the end 22 of the handlebar 20. A pivot mount 26 can be rigidly fixed to and can extend from the handlebar 20 generally perpendicular to and near the handle grip 24. The pivot mount 26 can be secured to the handlebar 20 with known materials and methods (e.g., fasteners, welding, etc.). The pivot mount 26 can include a base end 28 (i.e., first end), a cable end 30 (i.e., second end), a pivot hole 32, and a through hole 42 (shown in phantom). The lever assembly 10 can be operably coupled (e.g., pivotally coupled) to the pivot mount 26, adjacent the base end 28. More specifically, the lever assembly 10 can be pivotally attached to the pivot mount 26 at pivot hole 32 with known means such as with a rigid first pivot pin 58 (i.e., pivot barrel), thus providing a first pivot 60 and a first axis of rotation 62 for the lever assembly 10. Accordingly, the lever assembly 10 can pivot about the axis of rotation 62 to move between the neutral position and the actuated position as will be discussed in greater detail below.

The control system 12 can also include a coupling, such as a cable 34 having a protective outer sheath 36. A threaded mount 40 can grip a portion of sheath 36 to secure the sheath 36 in place. An end 38 of the cable 34 can extend out of the outer sheath 36 and can extend through the hole 42 in the pivot mount 26 to be secured to the lever assembly 10. The cable 34 can be sized and shaped to slide freely through the hole 42 in the pivot mount 26 and within the protective outer sheath 36 such that actuation of the lever assembly 10 thereby actuates the cable 34, as will be discussed in greater detail below. The opposite end (not shown) of the cable 34 can be operably secured to a hydraulic master cylinder, a brake caliper, an electric switch, a magnetic switch, a transducer, or other device of the system being controlled. It will be appreciated that the control system 12 could include another type of coupling other than the cable 34 for linking the lever assembly 10 to a braking system, clutch system, etc. Also, the cable 34 can be a direct, mechanical linkage between the lever assembly 10 and the controlled system, or the cable 34 can indirectly link the two (e.g., according to known drive-by-wire technology).

The end 38 of the cable 34 can be secured to the lever assembly 10 by a rigid cable retaining pin 46, and the pin 46 can be securedly received in an opening 48 (FIG. 1) of the lever assembly 10. Thus, when the user squeezes the lever assembly 10 toward the handle grip 24 (i.e., rotates the lever assembly 10 about the first axis 62), the end 38 can move in concert with the lever assembly 10 to thereby pull the cable 34, increase tension in the cable 34, and control the brake system, the clutch system, or whichever system is coupled to the cable 34. When the user releases the lever assembly 10, tension in the cable 34 can return the lever assembly 10 to its neutral position (shown in FIG. 1). The pivot mount 26 can include a defined stop 49 (FIG. 1) such that abutment between the lever assembly 10 and the stop 49 can limit the lever assembly 10 from pivoting away from the handlebar 20 beyond the predefined, neutral position. In other embodiments, such as those that do not include the cable 34, actuation of the lever assembly 10 can change the state of an electric switch from OFF to ON and vice versa to control the brake, clutch, or other system. Moreover, actuation of the lever assembly 10 can consequently actuate a piston within a hydraulic piston to control the associated system.

The lever assembly 10 will now be discussed in greater detail with reference to FIGS. 1, 2A, and 2B. The collapsible lever assembly 10 can include a base section 64 (i.e., first section), an intermediate section 66 (i.e., second section), and an elongate handle 68 (i.e., third section). The handle 68 can be defined by a first portion 69 and a second portion 71.

The handle 68 can be joined through intermediate section 66 to base section 64 in such a way as to provide a plurality (e.g., two) separate pivots. In some embodiments, these pivots can include a second pivot 70 providing a second axis of rotation 72, and a third pivot 74 providing a third axis of rotation 76. The lever assembly 10 is shown in its neutral position in FIGS. 1-2B, but the lever assembly 10 can collapse (i.e., move from the neutral position to one or more collapsed positions) by pivoting about one or both of the second and third axes of rotation 72, 76.

The base section 64 is pivotally connected to the pivot mount 26 via pivot pin 58 as set out above. The base section 64 also is joined to intermediate section 66 at second pivot 70, and intermediate section 66 is joined to handle 68 at third pivot 74. The lever assembly 10 can also include one or more biasing members 82, 87 that bias at least one of the second and third sections toward the neutral position as will be discussed in greater detail. In some embodiments, the biasing members 32, 37 can be helical, torsion springs; however, the biasing members 32, 37 can be of any other type without departing from the scope of the present disclosure.

In some embodiments, the second pivot axis 72 at second pivot 70 is generally perpendicular to the handle grip 24 and substantially parallel to the first axis of rotation 62 to permit the intermediate section 66 to pivot relative to the base section 64 as noted by arrow 78 (FIGS. 1 and 2A). The third axis of rotation 76 at third pivot 74 is generally perpendicular to the first and second axes of rotation 62, 72 to permit the handle 68 to pivot relative to the intermediate section 66 in the direction of arrow 80 (FIG. 2B).

The base section 64, the intermediate section 66, and the first and second portions 69, 71 of the handle 68 can each be constructed of a durable and rigid material. For instance, the base and intermediate sections 64, 66 and first and second portions 69, 71 can be made of steel or other metal, or any other suitable material.

The base section 64 can be somewhat L-shaped with a slat 65 on one end that is received between plates 67 of the pivot mount 26 (FIG. 1). The first pivot pin 58 extends through the slat 65 and the plates 67 to pivotably couple the base section 64 and the pivot mount 26 and to establish the first pivot 60. The base section 64 can also include the opening 48, which is located at the middle portion of the L-shaped base section 64. The opening 48 can receive the cable retaining pin 46 as discussed above.

Moreover, the base section 64 can include a pair of substantially flat plates 90 (FIGS. 2A and 2B), which are located opposite the slat 65. A portion of the intermediate section 66 can be received between the plates 90 and can be pivotably coupled thereto to establish the second pivot 70.

Additionally, the base section 64 can include an abutment surface 73, which is located adjacent the second pivot 70. The abutment surface 73 can be substantially flat and can lie within a plane that is substantially parallel to the second pivot axis 72.

The intermediate section 66 can include a slat 75 that is received between the plates 90 (FIG. 2B) of the base section 64. A pivot pin 81 can extend through each of the plates 90 and the slat 75 to thereby pivotally couple the intermediate section 66 and the base section 64 and to establish the second pivot 70 and the second pivot axis 72.

Moreover, the biasing member 82, such as a torsion spring or other suitable biasing member, can be operably coupled to the intermediate section 66 and the base section 64 to thereby bias the intermediate section 66 toward the neutral position (shown in FIG. 1) relative to the base section 64. In the embodiment shown, the biasing member 82 pivotally biases the intermediate section 66 toward the handle grip 24.

Furthermore, the intermediate section 66 can include an adjustment member 83 (FIGS. 1 and 2A) that selectively adjusts the neutral position of the lever assembly 10. In other words, the adjustment member 83 can allow the user to selectively adjust the angle θ (FIG. 1) between the longitudinal axis of the lever assembly 10 (when in its neutral position) and the longitudinal axis of the handlebar 20. In some embodiments, the adjustment member 83 can include a threaded member (e.g., a bolt) or other hardware that is threadably attached to the intermediate member and that partially protrudes toward the base section 64 to abut against the abutment surface 73. As such, the adjustment member 83 can be rotated (i.e., threadably advanced) to adjust the length of the portion of the adjustment member 83 protruding from the intermediate section 66 to thereby change the neutral position of the intermediate section 66 relative to the base section 64. Thus, the user can adjust the angle θ according to the user's particular hand size, etc.

Still further, the intermediate section 66 can include a projection 84 that is opposite the slat 75. The projection 84 can be forked in some embodiments. The projection 84 can be pivotably coupled to the handle 68 as will be discussed. The intermediate section 66 can also include one or more abutment surfaces 85 adjacent the projection 84 (FIG. 2B). The abutment surface(s) 85 can act as a stop that limits the range of pivoting movement of the handle 68 relative to the intermediate section 66 when moving between the neutral and collapsed positions as will be discussed. In the embodiments illustrated, the abutment surface(s) 85 are included on the underside of the intermediate section 66 (i.e., facing the ground) such that the abutment surface(s) 85 limit downward rotation of the handle 68; however, in other embodiments, the abutment surface(s) 85 can be located on the topside of the intermediate section 66 to limit upward rotation of the handle 68.

The first portion 69 of the handle 68 can include a pair of plates 93 that extend from one end thereof (FIGS. 1 and 2A), and the first portion 69 can also include an attachment portion 86 on an opposite end thereof. The projection 84 of the intermediate section 66 can be received between the plates 93. A pin 88 or other suitable fastener can extend through the plates 93 and the projection 84 to thereby pivotally couple the first portion 69 and the intermediate section 66 and to establish the third pivot 74 and third pivot axis 76. Moreover, a biasing member 87 can be operably coupled to the first portion 69 and the intermediate section 66 to thereby bias the first portion 69 toward the neutral position. In some embodiments, the biasing member 87 can include a torsion spring that is helically wound about the pin 88 and that is operably coupled to both the first portion 69 and the intermediate section 66. Also, the first portion 69 can include one or more projections 89 (FIG. 2B) that abuts against the abutment surfaces 85 of the intermediate portion 66 to thereby limit rotational movement of the first portion 69 relative to the intermediate section 66 and to thereby establish the neutral position of the first portion 69.

The lever assembly 10 can also include one or more fasteners 96, such as set screws, etc. (FIG. 2B). The fasteners 96 can extend through both the first portion 69 and the intermediate section 66 to thereby fix the first portion 69 against rotation relative to the intermediate section 66 about the third axis of rotation 76. Some users may not want the handle 68 to collapse by rotating about this axis 76; therefore, the fasteners 96 can prevent such rotation. However, other users might wish to remove the fasteners 96 to allow such rotation and collapse of the handle 68. (It will be appreciated that similar fasteners 96 could be included at the second axis of rotation 72 to prevent rotation of the intermediate section 66 relative to the base section 64.)

The second portion 71 of the handle 68 can be elongate and can be moveably coupled to the attachment portion 86 of the first portion 69 of the handle 68. Thus, the second portion 71 can move relative to the first portion 69 to thereby vary a dimension of the handle 68. In some embodiments, the second portion 71 can be slidably coupled to the first portion 69 to vary a length of the handle 68. For instance, either the first or second portion 69, 71 can include a linear rail (not shown), and the other can include a groove (not shown) that slidably receives the rail. Also, the handle 68 can include a pin 91 (FIGS. 1 and 2A) that is fixed to the first portion 69 and that extends through the second portion 71 (i.e., through the slot in the second portion 71). The second portion 71 can be moveably retained between the head of the pin 91 and the first portion 69 during relative sliding movement. Accordingly, the second portion 71 can telescopingly slide relative to the first portion 69. Also, a set screw 94 or other fastener can extend through corresponding holes 95a, 95b in the first and second portions 69, 71, respectively (shown in phantom in FIG. 2A). The second portion 71 can include a plurality of spaced apart holes 95b that can each individually align with the hole 95a in the first portion 69. Thus, the user can remove the set screw 94, telescopingly slide the second portion 71 relative to the first portion 69 to a desired length and re-insert the set screw 94 into the corresponding pair of aligned holes 95a, 95b. It will be appreciated, however, that the handle 68 can have any suitable feature for adjusting the length or other dimension thereof.

Moreover, the second portion 71 of the handle 68 can further include a bulb 92 on an end opposite the first portion 69. The bulb 92 can stop the user's fingers from inadvertently moving off the handle 68 during use.

Furthermore, as shown in FIG. 2B, the lever assembly 10 can include a transducer 39. The transducer 39 can be a light emitting device (e.g., a light emitting diode, etc.), a sound emitting device (e.g., a speaker, etc.), or any other type of transducer. The transducer 39 can be mounted in any suitable location, such as the front surface of the intermediate section 66. The transducer 39 can also be in communication with a switch 45 that selectively turns the transducer 39 ON and OFF. The switch 45 can be a mechanical switch or any other suitable type. The transducer 39 can be normally OFF, and the switch 45 can turn the transducer 39 ON when the intermediate section 66 rotates about the second axis 72 from its neutral position toward its collapsed position. As such, the transducer 39 can function as an alarm to passersby, for instance, if the vehicle is involved in an accident, causing the lever assembly 10 to collapse.

In some embodiments, the switch 45 can turn the transducer 39 ON when the intermediate section 66 rotates about the axis 72 beyond a threshold angle. It will also be appreciated that the switch 45 can turn the transducer 39 ON and OFF due to any other condition of the lever assembly 10 (e.g., due to rotation of the handle 68 about the third axis of rotation 76 beyond a threshold angle).

A user can install the lever assembly 10 on known pivot mounts 26 as described above. Once installed, the lever assembly 10 can pull the cable 34 and operate the associated brake, clutch, or other system by squeezing or otherwise pulling and rotating the lever assembly 10 toward the handlebar 20 about the first axis of rotation 62 in the direction of arrow 44 in FIG. 1 (i.e., by rotating the lever assembly 10 from its neutral position to its actuated position). In some embodiments, there is relatively little or no rotation of any portion of the lever assembly 10 about the second or third pivot axes 72, 76 during this rotation between the neutral and actuated positions under normal riding/driving conditions.

Should the vehicle inadvertently fall to the ground or other riding surface and/or should the lever assembly 10 impact another object, the resulting impact forces can cause the intermediate section 66 to pivot relative to the base section 64 about the second axis of rotation 72 and/or the forces can cause the handle 68 to pivot relative to the intermediate section 66 about the third axis of rotation 76 (i.e., the lever assembly 10 can move from its neutral position to one or more collapsed positions). Thus, the lever assembly 10 may collapse under these forces without breaking by pivoting about the additional two axes of rotation 72, 76. In particular, the handle 68 may pivot in the direction of arrow 80 (FIG. 2B) relative to the intermediate section 66, and/or the intermediate section 66 may pivot in the direction of the second arrow 78 (FIGS. 1 and 2A) relative to the base section 64.

Following collapse of the lever assembly 10, the biasing members 82, 87 can return the lever assembly 10 to its neutral position. Thereafter, the vehicle can continue to operate normally. Thus, the lever assembly 10 is less likely to need costly repairs, and the vehicle can likely be used immediately after the collision.

It will be appreciated that the lever assembly 10 can be modified in a number of ways and yet still fall within the scope of the present disclosure. For instance, any of the axes of rotation 62, 72, 76 and/or other structures can be oriented or positioned differently or otherwise modified so that the lever assembly 10 collapses in any predetermined direction and in any predetermined manner.

Also, the lever assembly 10 can have any suitable range of pivoting motion about any of the axes of rotation 62, 72, 76. In some embodiments, for instance, the range of angular movement about the second axis of rotation 72 is approximately one hundred thirty-five degrees (135°), and the range of angular movement about the third axis of rotation 76 is approximately one hundred twenty degrees (120°). This range of motion can occur in any suitable direction and the range of motion can be limited in any of the ways described above (e.g., abutting surfaces) or in any other suitable manner. Likewise, the sliding range of motion of the second portion 71 of the handle 68 relative to the first portion 69 can be approximately 40 millimeters (40 mm) or any other suitable range.

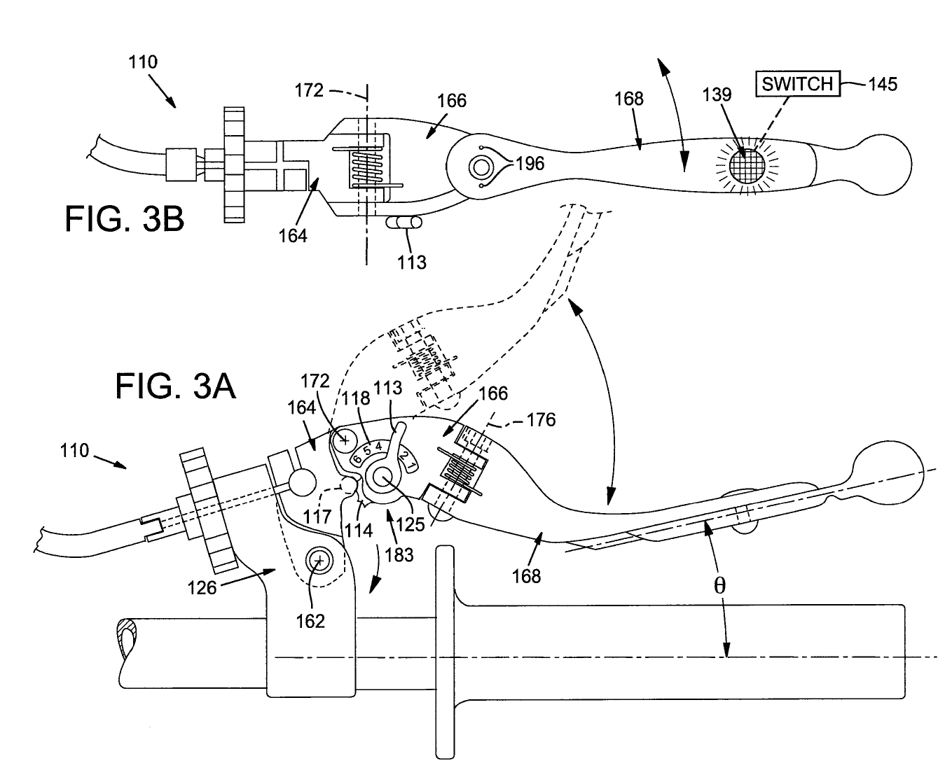

Referring now to FIGS. 3A and 3B, the lever assembly 110 is illustrated according to additional exemplary embodiments. Features that are similar to the embodiments of FIGS. 1-2B are indicated with corresponding reference numbers increased by 100.

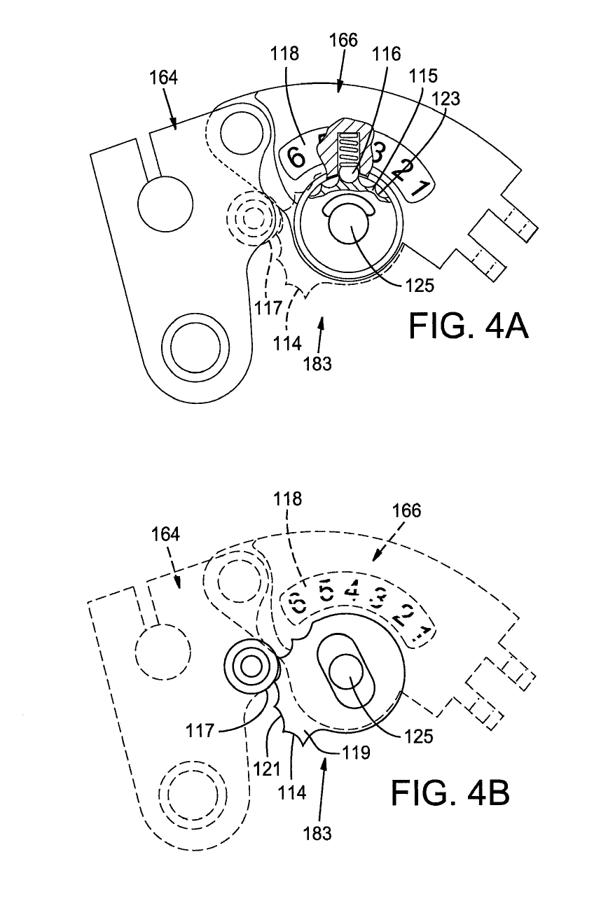

As shown, the lever assembly 110 can include an adjustment member 183 that is shown in detail in FIGS. 4A and 4B and that is different from the embodiments of FIGS. 1-2B. As shown, the adjustment member 183 can be a ratcheting-style adjustment member 183 (i.e., a ratchet assembly) with a set number of different neutral positions for the lever assembly 110.

Specifically, the adjustment member 183 can include a switch 113 (FIG. 3A), a cam plate 114 (FIG. 4B), a ratchet plate 115 (FIG. 4A), a pawl 116 (FIG. 4A), a bearing 117 (FIGS. 3A, 4A, and 4B), and an indicator 118 (FIGS. 3A and 4A). As shown, the indicator 118 can be a series of numbers (here, the numbers 1 to 6 arranged in a curved row) or other symbols that are included on the intermediate section 166. Also, the switch 113 can be a lever that is able to move over the symbols of the indicator 118.

As shown in FIG. 4B, the cam plate 114 can be a disc with a gradually radially extending eccentric portion 119 with a plurality of (e.g., six) detents 121 therein. As shown in FIG. 4A, the ratchet plate 115 can be a substantially circular or annular disc with a plurality of (e.g., six) detents 123. The number of detents 123 can be equal to or otherwise correspond to the number of detents 121 of the cam plate 114 and to the number of symbols included on the indicator 118.

The pawl 116 can be a ball bearing that is moveably received within a passage of the intermediate section 166. The pawl 116 can be biased outward (e.g., by a spring) from the intermediate section 166 toward the ratchet plate 115.

The bearing 117 can be a cylindrical bearing that is fixed to the base section 164, adjacent the cam plate 114. Also, the bearing 117 can include a bushing or a needle bearing. Thus, the bearing 117 can be selectively received in one of the detents 121 of the cam plate 114 as will be discussed.

In its assembled state, the cam plate 114, the ratchet plate 115, and switch 113 can be layered on top of each other and fixed together by a common pin 125. The pin 125 can be rotationally coupled to the intermediate section 166. Also, the switch 113 can be disposed on an external surface (e.g., a top surface) of the intermediate section 166 so that it can move partially over the indicator 118. Furthermore, the ratchet plate 115 and cam plate 114 can be disposed within or at least partially covered by the intermediate section 166.

Thus, when the user selectively rotates the switch 113, the cam plate 114 can rotate such that the eccentric portion 119 cams against the bearing 117 to thereby change the angle θ of the lever assembly 110 relative to the handlebar 120 (FIG. 3A). The bearing 117 can be received within a corresponding one of the detents 121 of the cam plate 114, and the pawl 116 can be biasingly received within the detents 123 of the ratchet plate 115 to thereby retain the lever assembly 110 at its selected angle θ. It will be appreciated that the relative position of the switch 113 and symbols of the indicator 118 can visually indicate the angle θ to the user. Accordingly, the ratcheting-style adjustment member 183 can allow the user to selectively adjust the angle θ (i.e., the neutral position) of the lever assembly 110 between a predetermined (e.g., six) number of settings, for instance, according to the particular hand size of the user.

The lever assembly 110 can also include the transducer 139, which is operably connected to the switch 145 (FIG. 3B). The transducer 139 can be located on a front surface of the handle 168.

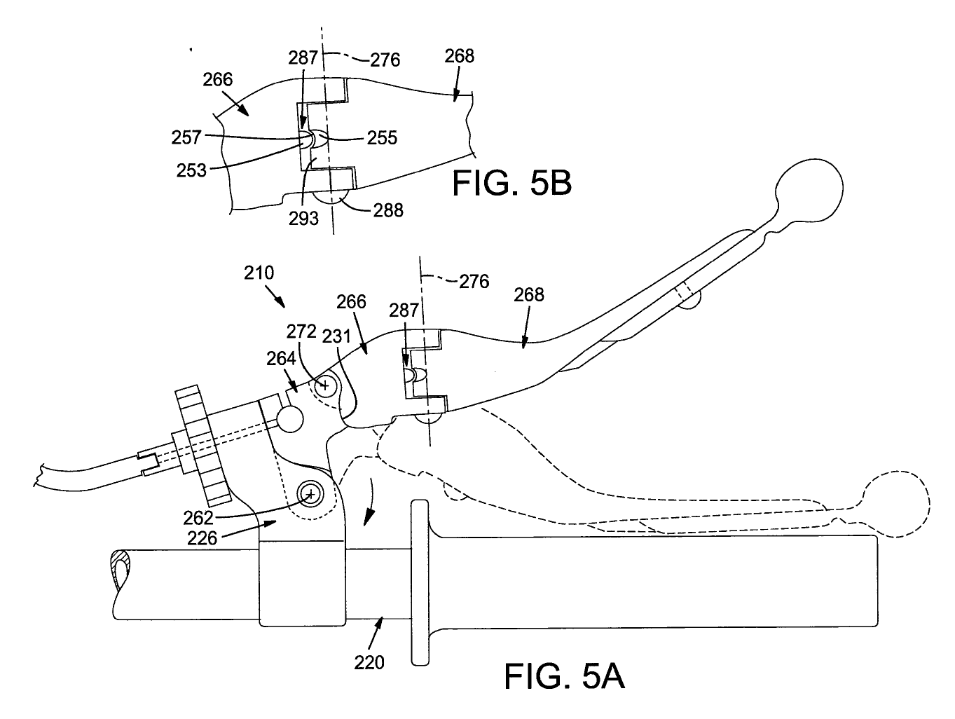

Referring now to FIGS. 5A and 5B, the lever assembly 210 is illustrated according to additional exemplary embodiments. Features that are similar to the embodiments of FIGS. 1-2B are indicated with corresponding reference numbers increased by 200.

As shown, the lever assembly 210 can include a stop 231 between the intermediate section 266 and the base section 264 for limiting relative rotational movement of the intermediate section 266 and the base section 264 about the second axis of rotation 272. The stop 231 can be rigid, abutting surfaces of the intermediate section 266 and the base section 264. For instance, the stop 231 can be located between the second axis of rotation 272 and the handlebar 220.

Also, as shown in FIG. 5B, the intermediate section 266 and the handle 268 can be pivotally joined by pin 288 to allow relative rotation about the axis 276. The handle 268 can be biased toward the neutral position via a biasing member 287. In the embodiments shown, the biasing member 287 can include a pawl 253, such as a ball bearing that is biased outward toward the handle 268. The handle 268 can include a groove 255 with a varying depth that curves about the plate 293 of the handle 268. The groove 255 can include a detent 257. The detent 257 can be the deepest section of the groove 255. The groove 255 and the detent 257 can each receive the pawl 253. The detent 257 can be located according to the neutral position of the handle 268 relative to the intermediate section 266. For instance, in the neutral position of the handle 268 relative to the intermediate section 266, the handle 268 and intermediate section 266 can share a common, straight axis, and the detent 257 can be centered on that common axis.

Thus, pawl 253 can be biased toward the detent 257 to thereby bias the handle 268 toward its neutral position relative to the intermediate section 266. Specifically, if the handle 268 rotates about the axis of rotation 276, the pawl 253 can retract into the intermediate section 266 while sliding across the interior surface of the groove 255. As the handle 268 moves further and further away from the neutral position, the pawl 253 can retract further and further into the intermediate section 266 due to the varying depth of the groove 255. Eventually, the handle 268 can move far enough away that it will abut against the intermediate section 266 to limit such movement.

It will be appreciated that the groove 255 can extend only in one direction away from the detent 257 to guide corresponding movement in that direction, or the groove 255 can extend from the detent 257 in opposite directions to increase the range of motion of the handle 268 about the axis of rotation 276.

Also, it will be appreciated that the handle 268 can include the pawl 253 while the intermediate section 266 includes the groove 255. Furthermore, a similar biasing member 287 can be included between the intermediate section 266 and the base section 264 for biasing the intermediate section 266 toward the neutral position.

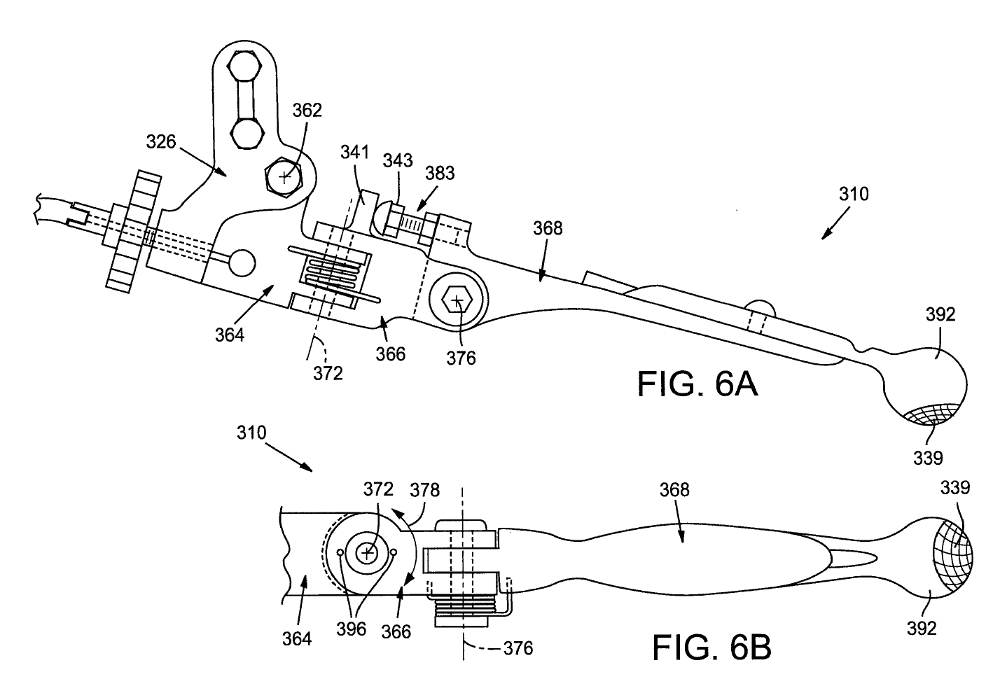

Referring now to FIGS. 6A and 6B, the lever assembly 310 is illustrated according to additional exemplary embodiments. Features that are similar to the embodiments of FIGS. 1-2B are indicated with corresponding reference numbers increased by 300.

As shown, the lever assembly 310 can include a base section 364 that is pivotally coupled to the pivot mount 326 for pivoting about a first axis of rotation 362. The lever assembly 310 can also include an intermediate section 366 that is pivotally coupled to the base section 364 for relative rotation about a second axis of rotation 372. Moreover, the lever assembly 310 can include a handle that is pivotally coupled to the intermediate section 366 for relative rotation about a third axis of rotation 376. As shown, the second axis of rotation 372 is oriented substantially perpendicular to the first axis of rotation 362, and the third axis of rotation 376 is substantially parallel to the first axis of rotation 362.

Moreover, the lever assembly 310 can include an adjustment member 383 that can adjust the neutral position of the handle 368 relative to the pivot base 326. The adjustment member 383 can limit relative rotation between the handle 368 and the intermediate section 366 about the axis of rotation 376. In particular, the intermediate section 366 can include a projection 341 (FIG. 6A) that projects toward the handlebar (not shown), and the adjustment member 383 can include a threaded member 343 that selectively abuts against the projection 341. The user can threadably advance the threaded member 343 in either direction to thereby change the length of the exposed portion of the threaded member 343. As such, the neutral position of the handle 368 relative to the intermediate section 366 can be adjusted.

Moreover, as shown in FIG. 6B, the intermediate section can pivot in both directions about the second axis of rotation 372. This is illustrated by arrow 378. However, the lever assembly 310 can include fasteners 396, such as set screws, that can fix the intermediate section 366 to the base section 364 (FIG. 6B). Similar to embodiments discussed above, the fasteners 396 can be removed the user desires the intermediate section 366 to be able to pivot about the second axis of rotation 372.

Additionally, the lever assembly 310 can include a transducer 339, similar to the embodiments discussed above. The transducer 339 can be a light emitted device that is included on the bulb 392 of the handle 368.

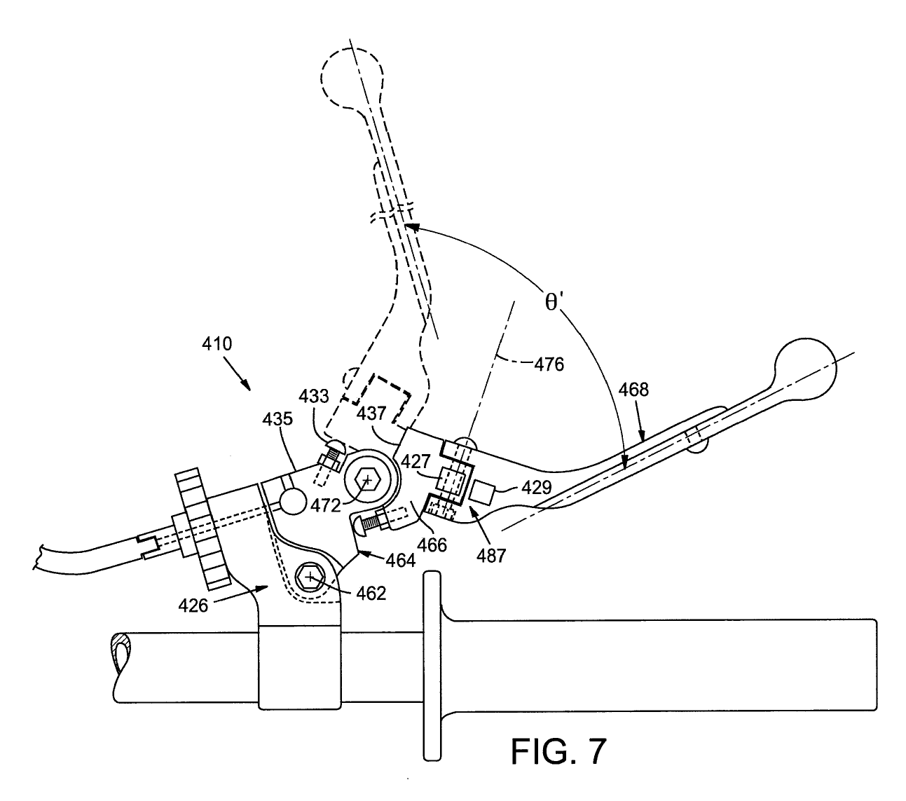

Referring now to FIG. 7, the lever assembly 410 is illustrated according to additional exemplary embodiments. Features that are similar to the embodiments of FIGS. 1-2B are indicated with corresponding reference numbers increased by 400.

As shown, the lever assembly 410 can be substantially similar to the lever assembly 10 of FIGS. 1-2B except as noted below. Accordingly, the lever assembly 410 can include a base section 464 that is pivotally coupled to the pivot mount 426 for pivoting about a first axis of rotation 462. The lever assembly 410 can also include an intermediate section 466 that is pivotally coupled to the base section 464 for relative rotation about a second axis of rotation 472. Moreover, the lever assembly 410 can include a handle 468 that is pivotally coupled to the intermediate section 466 for relative rotation about a third axis of rotation 476.

Moreover, the lever assembly 410 can include an adjustable limiter 433 that limits relative rotation between the intermediate section 466 and the base section 464. More specifically, the adjustable limiter 433 can project outwardly at an angle from a front face 435 of the base section 464, generally toward the intermediate section 466. The adjustable limiter 433 can be a bolt or other threaded member. As such, the adjustable limiter 433 can be removably coupled to the front face 435. Also, the adjustable limiter 433 can be advanced in either direction (e.g., threadably advanced) relative to the front face 435 to thereby adjust the length of the adjustable limiter 433 that projects from the front face 435. Thus, the intermediate section 466 can rotate about the second axis of rotation 472 from its neutral position (shown in solid lines), away from the handlebar 420, to its collapsed position (shown in phantom lines). In the collapsed position, a front face 437 of the intermediate section 466 abuts the adjustable limiter 433 to limit this relative rotation.

The range of rotation θ′ can be adjusted (increased or decreased) by threadably advancing the adjustable limiter 433. In some embodiments, the maximum range of rotation θ′ can be approximately 135° with the adjustable limiter 433 installed. Also, in some embodiments, the adjustable limiter 433 can be completely removed from the base section 464 to further increase the range of rotation θ′. For instance, the range of rotation θ′ can be limited by abutment between the front face 435 of the base section 464 and the front face 437 of the intermediate section 466. In this latter case, the range of rotation θ′ can be approximately 180°.

It will be appreciated that the limiter 433 could be embodied in a different manner without departing from the scope of the present disclosure. It will also be appreciated that a similar adjustable limiter could be included between the intermediate section 466 and the handle 468 for adjustably limiting relative rotation between the intermediate section 466 and the handle 468.

Furthermore, the lever assembly 410 can include a magnetic biasing member 487. More specifically, the magnetic biasing member 487 can include at least two magnets that are magnetically attracted to each other to bias the handle 468 toward its neutral position.

In the embodiments illustrated, the biasing member 487 can include a first magnet 427 and a second magnet 429. The first and second magnets 427, 429 can be of any suitable type. For instance, the first and second magnets 427, 429 can be permanent magnets (e.g., MAGCRAFT® rare-earth magnets that are commercially available from National Imports LLC of Vienna, Va.). In other embodiments, the first and/or second magnets 427, 429 can be electromagnets or other types of magnetized objects.

The first magnet 427 can be fixed to the intermediate section 466, and the second magnet 429 can be fixed to the handle 468, each adjacent the axis of rotation 476. The first and second magnets 427, 429 can be magnetically attracted such that the first and second magnets 427, 429 cooperate to bias the handle 468 toward its neutral position. In other words, the handle 468 can rotate about the axis of rotation 476 relative to the intermediate section 466 away from its neutral position, and the magnetic attraction between the first and second magnets 427, 429 can bias the handle 468 back toward its neutral position.

It will be appreciated that the lever assembly 410 can include any number of magnetic biasing members 487 for biasing any of the components back toward its respective neutral position. For instance, the intermediate section 466 can be biased toward its neutral position during rotation about the second axis of rotation 472 using a similar magnetic biasing member 487.

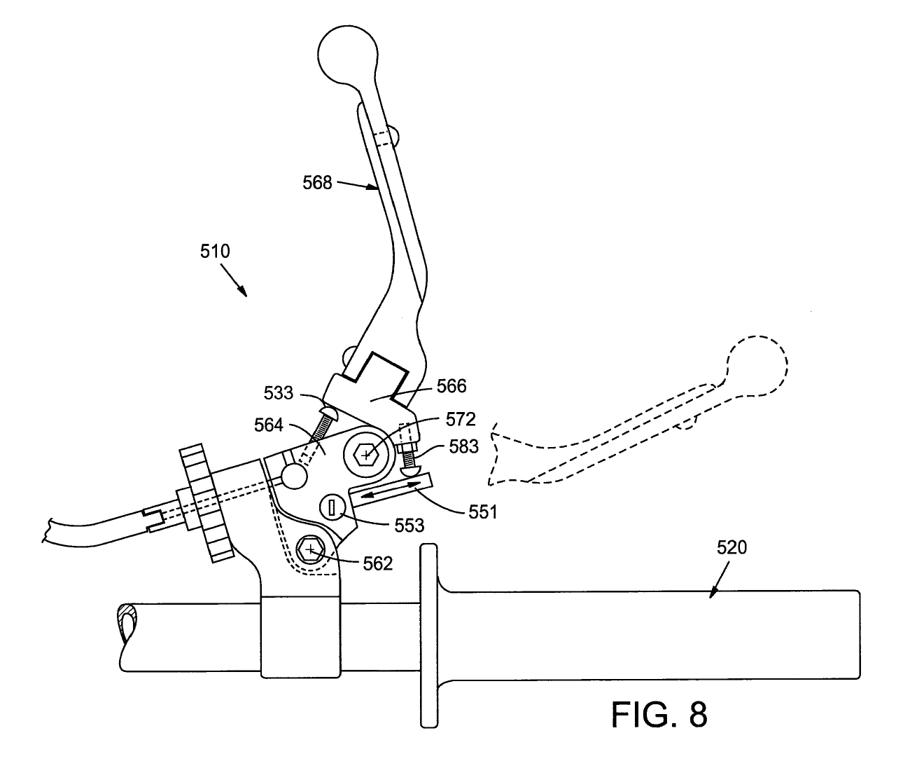

Referring now to FIG. 8, the lever assembly 510 is illustrated according to additional exemplary embodiments. Features that are similar to the embodiments of FIGS. 1-2B are indicated with corresponding reference numbers increased by 500.

As shown, the lever assembly 510 can include a retaining member 551 that selectively retains the lever assembly 510 in a certain position. For instance, the retaining member 551 can be a rigid, elongate member that can selectively extend out of the base section 564 (shown in FIG. 8) and that can also selectively retract into the base section 564 (not shown) as indicated by a double headed arrow. In its extended position (shown in FIG. 8), the retaining member 551 abuts against the adjustment member 583 to retain the intermediate section 566 in its collapsed position, positioned away from the handlebar 520.

The lever assembly 510 can also include a locking mechanism 553 that selectively maintains the retaining member 551 in at least one of its extended and retracted positions. The locking mechanism 553 can receive a key (not shown) for selectively locking and unlocking the retaining member 551 in position. Also, the retaining member 551 can be biased toward one of the extended and retracted positions.

Accordingly, the retaining member 551 can retain the lever assembly 510 in its collapsed position. This can be useful when the user parks the vehicle because it will be visually obvious that the lever assembly 510 will be unusable or inconvenient for applying the brakes, clutch, etc. of the vehicle. Thus, the retaining member 551 can function as a security device because a thief would be less likely to steal the vehicle when the lever assembly 510 is retained in the collapsed position.

It will be appreciated that the retaining member 551 can be of any suitable type other than that illustrated. The retaining member 551 can be a camming member, for instance, that cams the lever assembly 510 as it moves towards its collapsed position. Furthermore, the retaining member 552 can move linearly and/or rotationally as it moves between its neutral and collapsed positions. Also, it will be appreciated that the retaining member 551 could retain the lever assembly 510 in any suitable position other than that shown in FIG. 8. Moreover, the retaining member 551 can retain the handle 568 or any other portion of the lever assembly 510 in a position rotated away from its neutral position. For instance, in additional embodiments, the retaining member 551 retains the lever assembly 510 in a position rotated about the first axis of rotation 562, toward the handlebar 520, such that the brake remains applied when the retaining member 551 is in its collapsed position.

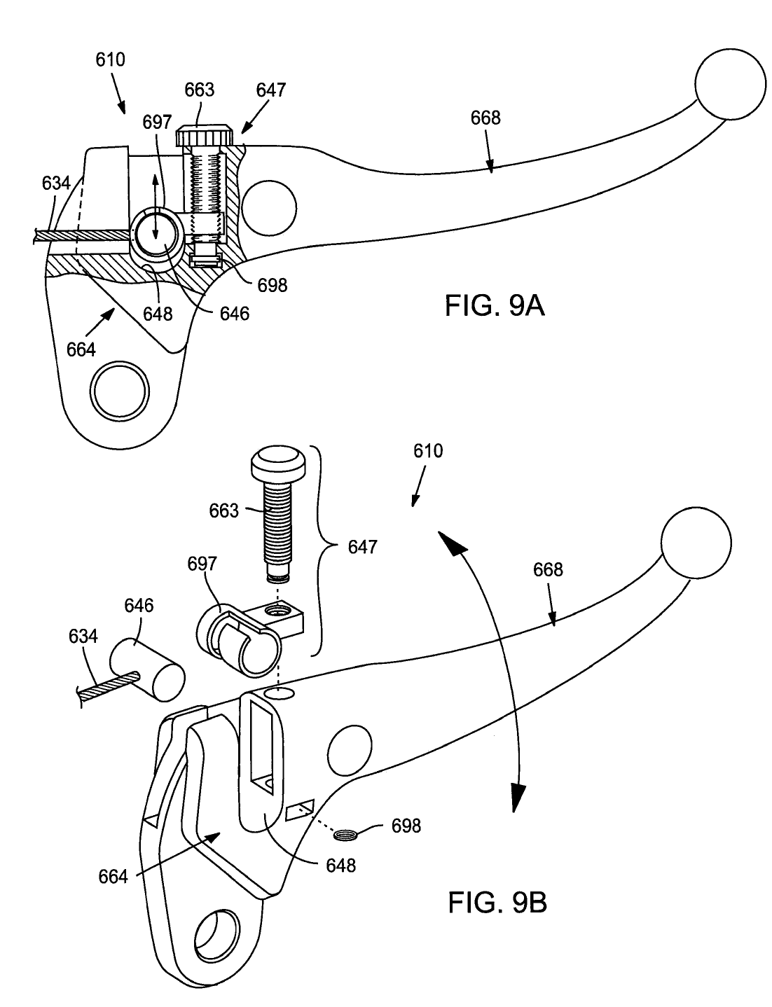

Referring now to FIGS. 9A and 9B, the lever assembly 610 is illustrated according to additional exemplary embodiments. Features that are similar to the embodiments of FIGS. 1-2B are indicated with corresponding reference numbers increased by 600.

As shown, the handle 668 can be fixed to the base section 664 of the lever assembly 610. However, in other embodiments, the handle 668 can pivot relative to the base section 664 similar to any of the embodiments discussed above. Also, in some embodiments, the lever assembly 610 can include an intermediate section that is disposed between and that is pivotally attached to both the base section 664 and the handle 668.

The lever assembly 610 can also moveably connect to an end of the cable 634 or other linkage via a linkage coupling 647 that moveably couples the cable retaining pin 646 to the base section 646. The linkage coupling 647 can include a receptacle 697 that receives the pin 646 and a threaded member 663 that is rotatably coupled to the base section 646. In the embodiments illustrated, the threaded member 663 is a bolt that is threadably engaged with the receptacle 697 and that is rotatably secured within the base section 646 via a retainer ring 698. By rotating the threaded member 663, the receptacle 697 can threadably advance relative to the threaded member 663. Specifically, the receptacle 697 can move linearly within the opening 648 along the axis of the threaded member 663 (indicated by double headed arrow in FIG. 9A).

Obviously, when the receptacle 697 moves, the pin 646 of the cable 634 moves therewith. Thus, the user can selectively change the position of the attachment between the cable 634 and the lever assembly 610. Thus, the user can change the amount of resistance force applied by the cable 634, can change the mechanical advantage provided by the lever assembly 610, etc.

It should be apparent that the embodiments discussed above can be modified in arrangement and detail without departing from the scope of the present disclosure. For example, although a lever assembly for use on the right side of a handle bar has been described, it should be apparent that the lever assembly described could be readily modified to be used on the left side of a handle bar simply by reversing the orientation of the components involved. Moreover, the shape and size of the base section may be readily modified to fit within a variety of commercially available pivot bases and easily accommodate the familiar brake, clutch, or other cable assemblies found on commercial motorcycles, bicycles, other vehicles, or other objects. Moreover, the lever assembly of the present disclosure will work equally well in a variety of environments unrelated to cable lever systems such as crank levers, hatch levers, adjustment levers, lever-type door knobs, and the like. Still further, features included in some illustrated embodiments of the lever assemblies 10, 110, 210, 310, 410, 510, 610 can be combined with other features of other illustrated embodiments without departing from the scope of the present disclosure.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A collapsible lever assembly for controlling a system, the lever assembly pivotable between a neutral position and an actuated position relative to a pivot base to control the system, the lever assembly also moveable between the neutral position and a collapsed position, the lever assembly comprising:
a first section that is pivotally attached to the pivot base to pivot about a first axis of rotation relative to the pivot base to move the lever assembly between the neutral position and the actuated position;
a second section that is pivotally attached to the first section to pivot about a second axis of rotation relative to the first section to move the lever assembly between the neutral position and the collapsed position; and
an adjustment member that selectively adjusts the neutral position of the lever assembly relative to the pivot base.

2. The collapsible lever assembly of claim 1, wherein the adjustment member includes a threaded member operable to be threadably advanced to thereby selectively adjust the neutral position of the lever assembly.

3. The collapsible lever assembly of claim 2, wherein the threaded member is threadably attached to one of the first and second sections and partially protrudes from the one of the first and second sections to abut the other of the first and second sections, a length of the threaded member protruding from the one of the first and second sections being variable by threadably advancing the threaded member to adjust the neutral position of the lever assembly.

4. The collapsible lever assembly of claim 1, wherein the adjustment member includes a ratchet assembly with a set number of different neutral positions for the lever assembly.

5. The collapsible lever assembly of claim 1, further comprising a third section that is pivotally attached to the second section to pivot about a third axis of rotation relative to the second section to move the lever assembly between the neutral position and the collapsed position.

6. The collapsible lever assembly of claim 5, wherein the third section includes a first portion of an elongate handle and a second portion of the elongate handle, the first portion of the elongate handle being pivotally attached to the second section to pivot about the third axis of rotation relative to the second section, the second portion of the elongate handle being moveably attached to the first portion to thereby vary a dimension of the elongate handle.

7. The collapsible lever assembly of claim 6, wherein the second portion of the elongate handle is slidably attached to the first portion to thereby vary a length of the elongate handle.

8. The collapsible lever assembly of claim 5, further comprising a biasing member that biases at least one of the second and third sections toward the neutral position.

9. The collapsible lever assembly of claim 8, wherein the biasing member includes at least two magnets that are magnetically attracted to each other to bias the at least one of the second and third sections toward the neutral position.

10. The collapsible lever assembly of claim 8, wherein the biasing member includes a pawl that is biased outward from one of the second and third sections, the other of the second and third sections including a groove of varying depth, the pawl being received in the groove and biased toward a deepest portion of the groove to thereby bias the at least one of the second and third sections toward the neutral position.

11. The collapsible lever assembly of claim 5, wherein the second and third axes of rotation are perpendicular to each other.

12. The collapsible lever assembly of claim 1, further comprising a linkage with an end that is moveably coupled to the first section, the end moving in concert with the first section when the first section pivots about the first axis of rotation to thereby control the system.

13. The collapsible lever assembly of claim 12, further comprising a linkage coupling that moveably couples the end of the linkage to the first section, the linkage coupling including a receptacle that receives the end of the linkage and a threaded member that is rotatably attached to the first section, the receptacle threadably advancing relative to the threaded member and moving linearly relative to the first section when the threaded member rotates relative to the first section.

14. A collapsible lever assembly for controlling a system, the lever assembly pivotable between a neutral position and an actuated position relative to a pivot base to control the system, the lever assembly also moveable between the neutral position and a collapsed position, the lever assembly comprising:
a first section that is pivotally attached to the pivot base to pivot about a first axis of rotation relative to the pivot base to move the lever assembly between the neutral and actuated positions;
a second section that is attached to the first section;
a third section that includes a first portion of an elongate handle and a second portion of the elongate handle, the first portion of the elongate handle being pivotally attached to the second section to pivot about a third axis of rotation relative to the second section to move the lever between the neutral position and the collapsed position, the second portion of the elongate handle being moveably attached to the first portion of the elongate handle to thereby vary a dimension of the elongate handle.

15. The collapsible lever assembly of claim 14, wherein the second portion of the elongate handle is slidably attached to the first portion of the elongate handle to thereby vary a length of the elongate handle.

16. The collapsible lever assembly of claim 14, wherein the second section is pivotally attached to the first section to pivot about a second axis of rotation relative to the first section to move the lever assembly between the neutral position and the collapsed position.

17. The collapsible lever assembly of claim 16, wherein the second and third axes of rotation are perpendicular to each other.

18. The collapsible lever assembly of claim 17, wherein the first and second axes of rotation are parallel to each other.

19. The collapsible lever assembly of claim 14, further comprising an adjustment member that selectively adjusts the neutral position of the lever assembly relative to the pivot base.

20. The collapsible lever assembly of claim 19, wherein the adjustment member includes a threaded member operable to be threadably advanced to thereby selectively adjust the neutral position of the lever assembly.

21. The collapsible lever assembly of claim 19, wherein the adjustment member includes a ratchet assembly with a set number of different neutral positions for the lever assembly.

22. A collapsible lever assembly for controlling a system, the lever assembly pivotable between a neutral position and an actuated position relative to a pivot base to control the system, the lever assembly also moveable between a neutral position and a collapsed position, the lever assembly comprising:
a first section that is pivotally attached to the pivot base to pivot about a first axis of rotation relative to the pivot base to move the lever assembly between the neutral position and the actuated position;
a second section that is pivotally attached to the first section to pivot about a second axis of rotation relative to the first section to move the lever assembly between the neutral position and the collapsed position; and
a linkage with an end that is moveably coupled to the first section, the end moving in concert with the first section when the first section pivots about the first axis of rotation to thereby control the system.

23. The collapsible lever assembly of claim 22, further comprising a linkage coupling that moveably couples the end of the linkage to the first section, the linkage coupling including a receptacle that receives the end of the linkage and a threaded member that is rotatably attached to the first section, the receptacle threadably advancing relative to the threaded member and moving linearly relative to the first section when the threaded member rotates relative to the first section.

24. The collapsible lever assembly of claim 23, wherein the linkage is a cable that is operably coupled to at least one of a braking system and a clutch system, wherein pivoting the lever assembly between the neutral position and the actuated position varies tension in the cable for actuating the at least one of the braking system and the clutch system.

25. The collapsible lever assembly of claim 22, further comprising an adjustment member that selectively adjusts the neutral position of the lever assembly relative to the pivot base.

26. The collapsible lever assembly of claim 25, wherein the adjustment member includes a threaded member operable to be threadably advanced to thereby selectively adjust the neutral position of the lever assembly.

27. The collapsible lever assembly of claim 25, wherein the adjustment member includes a ratchet assembly with a set number of different neutral positions for the lever assembly.

28. The collapsible lever assembly of claim 22, further comprising a third section that is pivotally attached to the second section to pivot about a third axis of rotation relative to the second section to move the lever assembly between the neutral position and the collapsed position, wherein the third section includes a first portion of an elongate handle and a second portion of the elongate handle, the first portion of the elongate handle being pivotally attached to the second section to pivot about the third axis of rotation relative to the second section, the second portion of the elongate handle being moveably attached to the first portion to thereby vary a dimension of the elongate handle.

29. The collapsible lever assembly of claim 28, wherein the second portion of the elongate handle is slidably attached to the first portion to thereby vary a length of the elongate handle.
